(19) United States
(12) Patent Application Publication
(10) Pub. No.: US 2013/0044125 A1
(43) Pub. Date: Feb. 21, 2013

(54) METHOD FOR DISPLAYING AN ELEMENTARY IMAGE OF A COMPOSITE IMAGE AND AN ASSOCIATED VIEWING DEVICE

(71) Applicant: Marc-Emmanuel Coupvent Des Graviers, Paris (FR)

(72) Inventor: Marc-Emmanuel Coupvent Des Graviers, Paris (FR)

(73) Assignee: MYRIAD FRANCE, Le Bourget-du-Lac (FR)

(21) Appl. No.: 13/490,025

(22) Filed: Jun. 6, 2012

(30) Foreign Application Priority Data
Jun. 6, 2011 (FR) 11 54897

(51) Int. Cl. G09G 5/00

(52) U.S. Cl. 345/629

(57) ABSTRACT

This method for displaying an elementary image of a composite image grouping several elementary images on a viewing device with memory, capable of allocating a global memory area for the processing of images, comprises:
a step for saving the composite image, and
a step for decoding and displaying on the viewing device elementary images from the composite image.

It further includes a transcoding step intended for recompressing the composite image, including:
a step for partitioning the composite image into a number of portions, and successively for each portion of the composite image:
   a step for decoding the sole portion of the composite image, and
   a step for recompressing the decoded portion of the composite image.

The decoding and displaying step is carried out from the recompressed composite image.

The present invention relates to a method for displaying an elementary image of a composite image grouping several elementary images, on a viewing device with a memory suitable for allocating a global memory area for the processing of images, the composite image having an initial compression format and a given initial size, the method comprising:
a step for saving the composite image in the global memory area allocated for the processing of images of the viewing device, and
a step for decoding and displaying on the viewing device, elementary images derived from the composite image.

The present invention also relates to a viewing device with a memory suitable for displaying an elementary image of a composite image grouping several elementary images, the composite image having an initial compression format and a given initial size, the device suitable for allocating a global memory area for the processing of images, comprising:
means for saving the composite image in the global memory area allocated for the processing of images of the viewing device, and
decoding and displaying means, intended for displaying on the viewing device elementary images stemming from the composite image.

Such a method for displaying a web page including elementary images on a viewing device of the aforementioned type is known.

This method consists of sending a request to a Web server, hosting the Web page, in order to download a composite image, more known under the name of <Sprite CSS>, (Sprite Cascading Style Sheet) on the viewing device. This image is set up beforehand by means of a known technique, used by website developers, which consists of grouping all the elementary images, i.e. all the icons and graphic elements of the Web page in a single large composite image, which is then compressed to the GIF (acronym of Graphics Interchange Format) format, or to the PNG (acronym of Portable Network Graphics) format.

Once the composite image is downloaded into the memory of the viewing device, this image is decoded so as to allow the Web page to use the elementary images, by means of the coordinates of each elementary image in the composite image, in order to achieve a complete display of the Web page on the viewing device.

Thus, with this technique, it is possible to recover all the elementary images of a given page through a single request to the server. Therefore, the time for loading the Web page on the viewing device is optimized since the number of requests to the server is reduced.

The problem is that, after decoding, the size of the composite image takes up a significant space in the memory of the viewing device. In the case when a composite image having elementary images of a fixed size or an encoding of pixels independent of the preceding pixels, a solution consists of only decoding the portion of the composite image comprising the elementary image to be displayed.

However, in the case of a composite image comprising elementary images without a fixed size, used as a background of HTML (HyperText Markup Language) elements, such as for example a text field, the elementary images are separated by large areas of white or empty pixels in order to avoid the display of several elementary images when the size of the HTML element is greater than the space allocated to the elementary image to be displayed. Thus, after decoding, the portion of the composite image comprising the text field strongly increases in this case, then occupying a large area of the memory of the viewing device.

Further, in the case of a composite image using a compression, for example PNG, format, having the property of encoding a given pixel from preceding pixels, it is not possible to decode a portion of the composite image without having to decode the composite image in its entirety. Thus, also in this case, the area occupied in the memory is significant.

In the case of viewing devices with limited memory, such as for example a mobile telephone, this problem may cause overflow of the memory allocated to the image processing or even of the total memory of the mobile, at least causing full non-display of the Web page, or even a more consequent malfunction of the viewing device, such as for example restarting of the viewing device.

The object of the invention is therefore to propose a method for displaying Web pages with which the occupied space may be optimized in the memory of the viewing device, by the composite image or by a portion of the composite image, after decoding so as to improve the display of Web pages comprising many elementary images.

For this purpose, the object of the invention is a display method of the aforementioned type, characterized in that it further includes a transcoding step intended for recompressing the composite image, according to a compression algorithm into a different final compression format and final size from the initial compression format and from the initial size, the transcoding step including:
a step for partitioning the composite image into a number of portions and successively for each portion of the composite image;
a step for decoding the sole portion of the composite image in a decoding memory area, within the overall memory area allocated to the image processing of the viewing device, and
a step for recompressing the decoded portion of the composite image into a final compression format within a memory area allocated to the processing of the composite image with the final compression format,

and in that the decoding and display step is carried out from the recompressed composite image.

According to other embodiments, the display method comprises one or several of the following features, taken individually or according to all the technically possible combinations:
the transcoding step further successively includes for each portion of the composite image, a step for freeing the decoding memory area, within the global memory area allocated to the image processing of the viewing device;
the step for partitioning the composite image is capable of defining each portion of the composite image in a number of lines of pixels;
the recompression step includes a step for adding an index table, intended to determine the position of the elementary images of the composite image with the final compression format in the global memory area allocated to image processing;
it further includes a step for comparison between the size of the composite image with the initial compression format and a predefined initial size, intended to initiate the transcoding step;
it further includes a step for comparison between the final size of the whole of the recompressed portions of the composite image and a final predefined size (84) intended to stop the transcoding step;
the initial format for compressing the composite image is an element from the group consisting in: GIF, and PNG;
the viewing device is a mobile telephone.

The object of the invention is also a display device of the aforementioned type characterized in that it further includes transcoding means, intended for recompressing the composite image, according to a compression algorithm, into a different final compression format and final size from the initial compression format and from the initial size, the transcoding means including:
means for partitioning the composite image into a certain number of portions, and successively for each portion of the composite image:
means for decoding the sole portion of the composite image in the decoding memory area, within the global memory area allocated to image processing of the viewing device, and
means for recompressing the decoded portion of the composite image into a final compression format within a memory area allocated to the processing of the composite image with the final compression format,

and in that the decoding and display means are applied to the recompressed composite image.

These features and advantages of the invention will become apparent upon reading the following description, only given as a non-limiting example, and made with reference to the appended drawings, wherein:

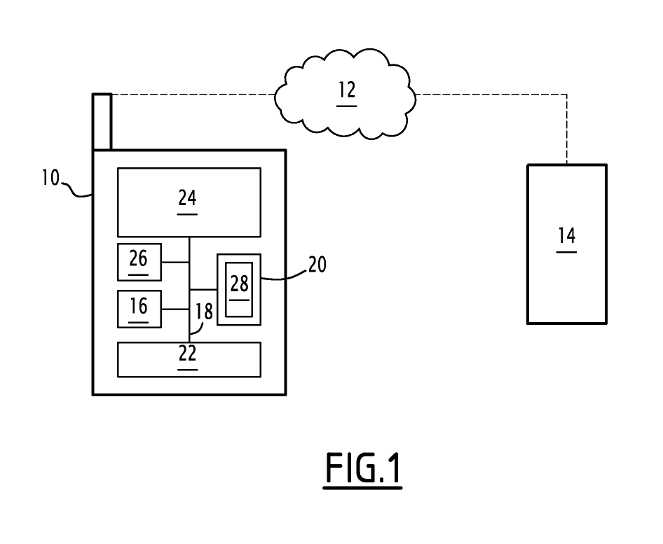

FIG. 1 is a schematic illustration of a global system illustrating the application of a viewing device according to the invention,

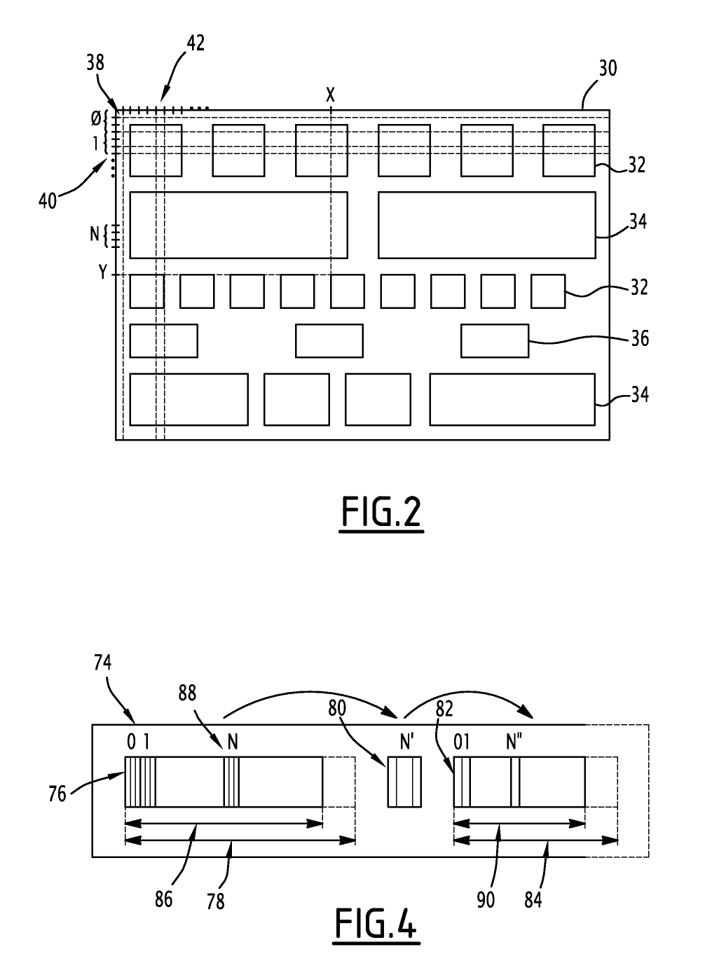

FIG. 2 is a schematic illustration of a composite image,

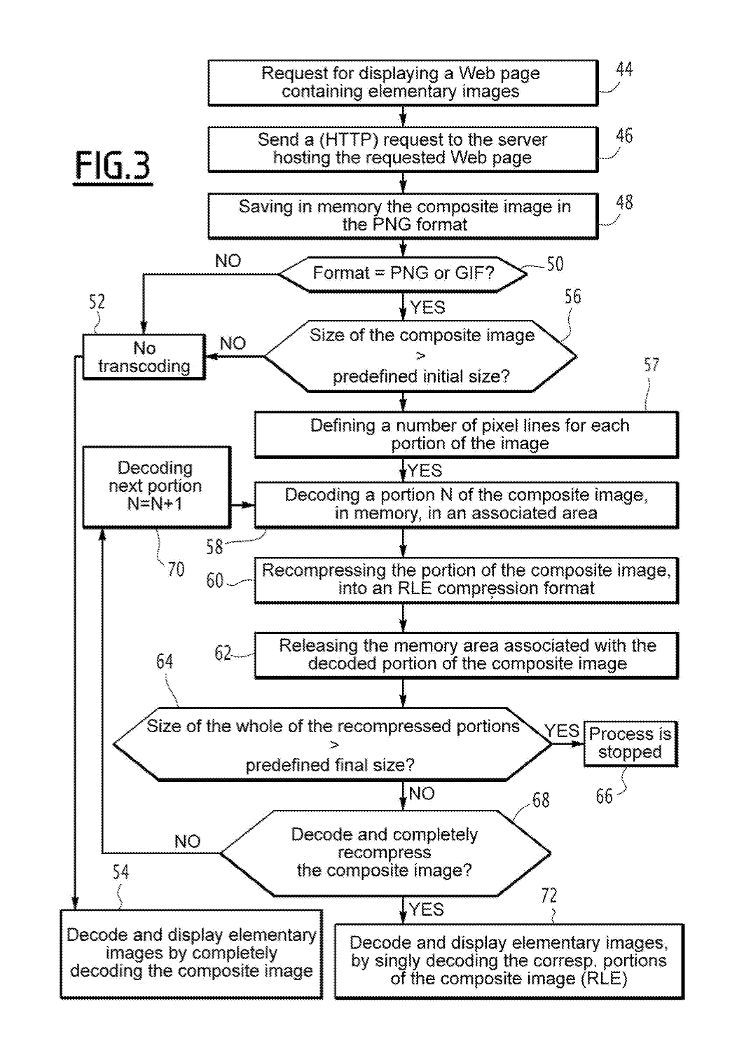

FIG. 3 is a flow chart of the display method according to the invention, and

FIG. 4 is a schematic illustration of a transcoding example achieved in the memory of a viewing device according to the invention.

A global system is seen in FIG. 1, comprising a viewing device 10 according to the invention, such as for example a mobile telephone, capable of interacting with a mobile telephone network 12 in order to establish a communication with a remote electronic device 14, such as a server for example, with the purpose of exchanging data.

More specifically, the viewing device 10 comprises different electronic components required for its operation, such as for example a central processing unit 16 connected to a data bus 18, allowing exchange of information with the whole of the other components of the viewing device 10, such as one or several memories 20, a user interface 22 and a display screen 24.

The viewing device 10 also comprises communication means 26 allowing exchange of data with the mobile telephone network 12. The different components are interconnected together by means of the data bus 18.

The central unit 16 is capable of executing applications included in the memory 20, notably an operating system allowing conventional operation of a viewing device 10.

The memory 20 includes different memory areas, allocated statically or dynamically depending on the executed applications. For example, in the case of applications requiring a display and/or manipulation of images, a global memory area is allocated for image processing.

The memory 20 also comprises a known application of the Web navigator type 28, capable of being executed by the central processing unit 16, in order to allow access to the remote electronic device 14, such as a server belonging to a remote network, such as the Internet network for example.

The server is capable of hosting a set of pieces of information such as for example Web pages in the case of a Web server. These Web pages generally comprise elementary images, these elementary images being grouped in a composite image, stored on the server.

The user interface 22 allows a user to interact with the Web navigator 28 when the latter is executed by the central unit 16.

The display screen 24 is capable of providing the user with viewing of different pieces of information stemming from applications executed by the central unit 16, such as for example a Web page provided by the Web navigator.

Advantageously, the screen and the user interface appear in a common form, in this case a touch screen for example.

FIG. 2 illustrates a composite image 30 which comprises different elementary images, such as for example icons 32, photographic images 34 or text fields 36.

Each elementary image is located by coordinates (X,Y) intended for the Web page in order to properly display each elementary image.

The composite image 30 consists of a set of points or pixels 38 contained in a two-dimensional table comprising lines 40 and columns 42. The number of pixels making up the image is called the definition, i.e. the number of columns multiplied by the number of lines. Thus, an image having 640 pixels in width and 480 in height has a definition noted as 640×480.

The file containing the image 30 consists of a set of values representing the color or the intensity of each pixel, coding being used in order to encode the value on a certain number of bits, or weights of the pixel, in order to determine the color or the intensity of the pixel.

In order to determine the size or weight of the image, it is necessary to count the number of pixels which the image contains and then to multiply this figure by the weight of each pixel. For example, a 640×480 image, with a coding of each pixel on 24 bits, has a size or weight of 900 kilobytes.

Taking into account the bulky nature of this type of file, a compression technique for example GIF or PNG, is used for storing images in the server 14, with which a reduced size of the file may be obtained.

Now, the method for displaying a Web page on the viewing device 10 will now be described, according to FIG. 3.

During a step 44, by means of the Web navigator 28, the user performs a request for display of a Web page comprising elementary images 32, 34, 36, for example icons or graphic elements, through the user interface 22.

The display request is processed by the central processing unit 16 and a request, for example an http (acronym of HyperText Transfer Protocol) request, is sent by the communication means 26 through the mobile telephone network 12 to the remote electronic device 14 hosting the requested Web page, for example a Web server, as illustrated by step 46.

Upon receiving this request, the Web server sends the information associated with the requested Web page, such as for example text elements or graphical elements. More particularly, the graphical elements or elementary images 32, 34, 36 are sent through a single graphical file comprising an image consisting of the whole of the elementary images 32, 34, 36 of the requested Web page.

Thus, the composite image 30 is transmitted by the server 14 to the viewing device 10 in a compressed form, at the end of step 46.

During a step 48, after reception, the composite image 30 is saved in the memory 20 of the viewing device 10 in an initial compression format. More particularly, the composite image 30, in the GIF format for example is saved in the global memory area for processing images of the viewing device 10.

Advantageously, as the composite images are generally of the GIF or PNG type, a test of the initial compression format is conducted, during a step 50 in order to check whether the format of the composite image is of the GIF or PNG type before passing to the following step.

When the image 30 is of a different type, for example a JPEG type, no additional processing according to the invention is carried out during a step 52 and the contents of the composite image 30 is displayed, after complete decoding of the composite image 30, achieved in a way known per se during a step 54.

If the composite image 30 is in the GIF or PNG format, preferably the following step corresponds to a step 56 for comparison between the size of the composite image and a predefined initial size.

When the size of the composite image 30 is less than a predefined initial size, for example corresponding to the size of an allocated memory area for processing of an image, no additional processing according to the invention is carried out in step 52 and, as explained earlier, the contents of the composite image are displayed, after complete decoding during step 54.

In the opposite case, when the size of the composite image 30 is larger than the predefined initial size, a transcoding of the composite image 30 is initiated in order to achieve conversion of the initial compression format into a final compression format intended to reduce the size of the composite image 30.

During a step 57, the composite image 30 is divided into a set of blocks or of portions, each portion 88 of the composite image 30 for example comprising a defined number of lines 40 of pixels.

During a step 58, decoding of a portion N of the composite image 30, for example a block N of three lines of pixels as illustrated in FIG. 2, is carried out within a decoding memory area of the memory 20.

Next, during a step 60, the decoded portion of the composite image is recompressed into a final compression format according to a compression algorithm.

For example, the compression algorithm is an RLE (acronym of Run Length Encoding) algorithm which consists of locating and of removing the repetition of successive data.

Advantageously, an index table is added during recompression suitable for subsequent determination of the position in memory 20 of the elementary images 32, 34, 36 according to the line number 40 of the composite image 30.

During a step 62, the decoding memory area, used in step 58 for decoding the portion N of the composite image 30, is released so that it may be reused.

Preferably, during a step 64, a comparison is carried out between the size of the whole of the recompressed portions of the composite image 30 in the final compression format, and a predefined final size, corresponding for example to the size of a memory area allocated to the processing of an image, in order to avoid memory overflow 20.

When the size of the whole of the recompressed portions of the composite image 30 is larger than the predefined final size, the method is interrupted in step 66 and the elementary images associated with the Web page are not displayed.

In the opposite case, as indicated in step 68, a test is conducted in order to determine whether the composite image 30 is decoded and recompressed in its entirety.

If this is not the case, the method passes to the processing of another portion of the composite image 30, during a step 70 and then the method continues to step 58 by the decoding of this non-decoded portion of the composite image, for example a portion N+1 of the composite image 30.

Once the composite image 30 is decoded and entirely recompressed into the final recompression RLE format, display of the elementary images 32, 34, 36 of the Web page is performed after only decoding, during step 72, the corresponding portions of the composite image 30 by using the index table added beforehand.

The steps for decoding 58 and recompressing 60 the portion of the composite image into the RLE format, will now be described in detail.

FIG. 4 illustrates an example for transcoding a block N with the initial compression format of the composite image 30, illustrated in FIG. 1, into a block N″ in a final compression formation, within a global memory area 74 allocated to the processing of images in the memory 20 of the viewing device 10.

The global memory area 74 allocated to the processing of images comprises different memory areas intended for processing of images before their display on the screen 24 of the viewing device 10. More particularly, the global memory area 74 comprises a memory area 76 allocated to the processing of a composite image 30 with the initial compression format, of a predefined size 78, a decoding memory area 80 specific to the decoding of a block N of the composite image 30 and a memory area 82 of a predefined size 84, allocated to the processing of the composite image 30 in the final compression format.

Thus, at the beginning of step 58, from the composite image 30 with initial size 86, saved in the memory area 76 allocated to the processing of a composite image 30 in the initial compression format, the central unit 16 processes a portion of the composite image 30, for example a block N 88 of three lines of pixels, allowing the data of the composite image 30 to be retrieved before coding into the initial compression format. Each pixel line of the block N is decoded, in the decoding memory area 80, a decoder specific to the initial compression format being used for achieving this operation. For example, in the case of an image in the initial compression format GIF, a GIF decoder is used.

After decoding, the block N is converted into a block N′.

Next, recompression of the block N′ into a block N″ is carried out, corresponding to step 60, according to a compression algorithm. In the case of an RLE algorithm, the block N″ is called an RLE block, and the whole of the RLE blocks associated with the composite image 30 in the final compression format corresponds to an RLE file.

More specifically, the RLE algorithm consists of replacing in a set of elements, a sequence of n identical [symbol] elements V [symbol] with a pair (n,V), the first byte indicating the number of identical characters to be compressed, and the second the character to be compressed. As an example, the chain [symbol] OA OA OA OA OA OA [symbol] is compressed in the form of [symbol] 6A [symbol] .

During the recompression, in a preferred way, an index table is added, specific to the subsequent determination of the position of the elementary images 32, 34, 36 in the composite image 30.

The index table is built during the execution of the process described by FIG. 3. Each element of this table, called an index, is a pair (D,R).

D corresponding to a shift, points towards an RLE block in the RLE file of the composite image 30, an RLE block corresponding to an RLE compression unit, i.e. <6A> in the example indicated above. As an example, an index is added every ten RLE blocks.

R, or rank of the pixel is equal to x+y*n, wherein (x,y) are the coordinates in the composite image 30, of the first pixel encoded by the RLE block to which points D, and n is number of pixels per line 40 of the composite image 30. Advantageously, the index table is sorted in the increasing order of Rs.

At the end of the recompression step 60, the block N′ is converted into a block N″, or RLE block in the relevant example.

After complete transcoding of the composite image 30, the whole of the blocks of the composite image occupies a final size 90 of the memory area 82 allocated to the processing of a composite image in the final compression format, this final size 90 being less than the initial size 86.

During the display of a Web page including a composite image 30 of the [symbol] Sprite CSS [symbol] type, the HTML code of the Web page has access to the elementary images 32, 34, 36 of the composite image 30 by using the coordinates (x,y) of the pixel located on the upper left corner of these elementary images 32, 34, 36 as well as their width and height.

These coordinates (x,y) are transformed into the rank of the pixel Rs by using the formula above. The index table is covered until an index I_{T} is found such that I_{T}=(D_{T},R_{T}) for which R_{T} is less than or equal to Rs. The shift D_{T} is then used for having access to the corresponding RLE block and finally a progression by a number of positions equal to (R_{S}−R_{T}) in the following RLE block(s) is performed in order to have access to the value of the pixel on the upper left of the sought elementary image 32, 34, 36. The other pixels of the elementary image 32, 34, 36 are retrieved by progressing in the following RLE blocks.

Consequently, the device 10, by using the method according to the invention, is able to display an elementary image of a Web page by only decoding a portion of the composite image, thereby allowing a reduction in the space occupied in memory for the decoding.

Thus, with the invention, it is possible to properly display Web pages using the CSS Sprite technique, notably on viewing devices with limited memory.

1. A method for displaying an elementary image from a composite image grouping several elementary images (32, 34, 36), on a viewing device (10) with a memory (20) capable of allocating a global memory area (74) for the processing of images, the composite image (30) having an initial compression format and a given initial size (86), the method comprising:
a step (48) for saving the composite image (30) in the global memory area (74) allocated for the processing of images of the viewing device (10), and
a step for decoding and displaying (72) on the viewing device (10), elementary images (32, 34, 36) derived from the composite image (30),
characterized in that it further includes a transcoding step intended for recompressing the composite image (30) according to a compression algorithm into a different final compression format and final size (90) from the initial compression format and from the initial size (86), the transcoding step including:
a step (57) for partitioning the composite image (30) into a number of portions (88), and successively for each portion (88) of the composite image (30):
a step (58) for decoding the sole portion (88) of the composite image (30) in a decoding memory area (80), within the global memory area (74) allocated to the processing of images of the viewing device (10), and
a step (60) for recompressing the decoded portion of the composite image (30) into a final compression format within a memory area (82) allocated to the processing of the composite image (30) in the final compression format, and
in that the decoding and display step (72) is carried out from the recompressed composite image (30).

2. The display method according to claim 1, characterized in that the transcoding step further successively includes for each portion (88) of the composite image (30) a step (62) for freeing the decoding memory area (80), within the global memory area (74) allocated to the processing of images of the viewing device (10).

3. The display method according to any of the preceding claims, characterized in that the step (57) for partitioning the composite image (30) is capable of defining each portion (88) of the composite image (30) in a number of lines (40) of pixels.

4. The display method according to any of the preceding claims, characterized in that the recompression step (60) includes a step for adding an index table, intended to determine the position of the elementary images (32, 34, 36) of the composite image (30) in the final compression format in the global memory area (74) allocated to the processing of images.

5. The display method according to any of the preceding claims, characterized in that it further includes a step (56) for comparison between the size (86) of the composite image (30) in the initial compression format and a predefined initial size (78), intended for initiating the transcoding step.

6. The display method according to any of the preceding claims, characterized in that it further includes a step (64) for comparison between the final size (90) of the whole of the recompressed portions of the composite image (30) and a predefined final size (84) intended for stopping the transcoding step.

7. The display method according to any of the preceding claims, characterized in that the initial compression format of the composite image (30) is an element from the group consisting in: GIF and PNG.

8. The display method according to any of the preceding claims, characterized in that the viewing device (10) is a mobile telephone.

9. The viewing device (10) with a memory (20), capable of displaying an elementary image of a composite image grouping several elementary images (32, 34, 36), the composite image (30) having an initial compression format and a given initial size (86), the device (10) capable of allocating a global memory area (74) for the processing of images, comprising:
means (20) for saving the composite image (30), in the global memory area (74) allocated for the processing of images of the viewing device (10), and
decoding and display means, intended for displaying on the viewing device (10), elementary images (32, 34, 36) derived from the composite image (30),
characterized in that it further includes transcoding means, intended for recompressing the composite image (30), according to a compression algorithm, into a final compression format and final size (90) which are different from the initial compression format and from the initial size (86), the transcoding means including:
means for partitioning the composite image (30) into a number of portions (88) and successively for each portion (88) of the composite image (30):
means for decoding the sole portion (88) of the composite image (30) in the decoding memory area (80), within the global memory area (74) allocated to the processing of images of the viewing device (10), and
means for recompressing the decoded portion of the composite image (30) into a final compression format within a memory area (82) allocated to the processing of the composite image (30) in the final compression format,
and in that the decoding and display means are applied to the recompressed composite image (30).
